(19) United States
(12) Patent Application Publication
(10) Pub. No.: US 2026/0363381 A1
(43) Pub. Date: Nov. 19, 2026

(54) ELECTRONIC COMMUNICATION HAT

(71) Applicants: SHELAGH XIAOCUI LI, YARDLEY, PA (US); XIAOCHANG CHARLES LI, YARDLEY, PA (US)

(72) Inventors: XIAOCHANG CHARLES LI, YARDLEY, PA (US); EDWARD WEIDE LI, YARDLEY, PA (US); SHELAGH XIAOCUI LI, YARDLEY, PA (US)

(21) Appl. No.: 19/206,329

(22) Filed: May 13, 2025

(51) Int. Cl. A42B 3/30; A42B 3/04; H02J 7/35

(52) U.S. Cl. CPC A42B 3/30; A42B 3/042; H02J 7/35

(57) ABSTRACT

An electronic communication hat comprising: a hat top, a hat body, and a hat brim solar cell module. The hat top includes multiple first zones and each of which is a sub solar cell module; The hat body includes multiple second zones and each of which is a subsolar cell module; The hat brim includes multiple third zones and each of which is a sub solar cell module. The multiple sub solar cell modules of the hat are connected in parallel circuits; Each sub solar cell module includes multiple solar cells, which are connected in series circuit; An anti-backflow device is used to prevent the reverse current conduction of each sub solar cell module. The present invention can improve the photovoltaic efficiency and provide more stable and longer time of power supply for an electronic communication hat wherein audio, video apparatus be integrated.

### TECHNICAL FIELD

the present invention relates to the field of mobile solar cell equipment that can supply power for intelligent wearable audio, video communication devices.

### TECHNOLOGY BACKGROUND

with the advancement of handheld communication device functions, mankind can hardly live without it. At present, when using a mobile phone, it is inevitable to hold it with head down and watch a limited display screen, which leads to cervical spondylosis caused by the “head down tribe”. The inevitable use of a mobile phone while walking or strolling also brings safety hazards, such as the risk of collision with others, road signs, trees and other obstacles, and even tripping. In addition, the possession of mobile phones hinders the freedom of movement of both hands. In short, the popularity and use of smartphones have prevented modern people from freeing their “hands and neck”.

in order to improve the shortcomings of the above-mentioned mobile phones, one of the existing methods is to use wired or wireless bluetooth connected headphones to facilitate mobile phone calls, temporarily releasing one or both hands for voice interaction, which has the advantages of simplicity and convenience. However, the disadvantage is that it is impossible to watch informative content such as pictures, text, emails, short videos, movies, etc. Obtained through mobile communication. For convenient watching pictures, videos, and movies, virtual reality goggles (vr) have been launched in the market, which are characterized by immersive viewing, especially 3d viewing for achieving unprecedented audio-visual effects, as if experiencing a realistic virtual effect. However, the resulting eye fatigue effect and inability to simultaneously observe the surrounding environment limit their use as a communication tool. Recently, augmented reality glasses (ar) have also been launched, aiming to overlay digital information into users' reality through augmented reality technology. Users can interact with the device through voice, gestures, or head movements. The transparent display screen used can display notifications, text messages, emails, short videos, movies, and other information in real time while watching the surroundings. The ar glasses support voice commands, reducing the trouble of manual operation and making it very convenient for users who operate other tools with both hands. It helps complex assembly line workers to interact and guide work, improve work accuracy and efficiency. However, its display ability is still limited, mainly focusing on information display, and cannot provide complex 3d images and holographic images. Besides, the battery life is limited to 2-3 hours use; the recently launched mr (mixed reality) belongs to the fusion of mixed augmented reality (ar) and virtual reality (vr) technologies, with 3d precision display. Mr finds its application in fields such as healthcare, education, entertainment, and manufacturing. Its high-power consumption and eye fatigue caused by wearing and watching, combined with discomfort from cheek load, as well as its battery life of only 2-3 hours, hinder its possibility of becoming a new generation of mass communication device.

### SUMMARY

the present invention provides an electronic communication hat, which can improve the utilization efficiency of light to generate photovoltaic electricity in a reliable and green energy generation way, and at the same time to power mobile communication devices, such as a walkie-talkie, a mobile phone, a xr glass, etc.

according to one aspect of the present invention, an electronic communication hat comprising: flexible thin-film solar module, the top, body, and brim of the electronic communication hat are all made of flexible thin-film solar modules. The flexible thin-film solar module on the top of the hat is the first solar cell module, the flexible thin-film solar module on the body of the hat is the second solar cell module, and the flexible thin-film solar module on the brim is the third solar cell module; the first solar cell module, the second solar cell module, and the third solar cell module are connected in parallel circuit. The flexible thin film solar module on the top of the hat includes multiple first zones with the same area, each of which is a sub solar cell module. The multiple sub solar cell modules on the top of the hat are connected in parallel circuit; the flexible thin film solar module of the hat body includes multiple second zones with the same area, each second zone being a sub solar cell module, and the multiple sub solar cell modules of the hat body are connected in parallel circuit; the flexible thin film solar module of the brim includes multiple third zones with the same area, each of which is a sub solar cell module; the multiple sub solar cell modules of the brim are connected in parallel circuit; each sub solar cell module includes multiple solar cells, which are connected in series circuit; the number of multiple solar cells can be m, with m ranging from 2-20; anti-backflow device, used to prevent reverse current conduction of each sub solar cell module, can be a reverse current or reverse power protection device.

optionally, the anti-backflow device includes multiple anti-reflux diodes.

the output terminal of each sub solar cell module is connected in series with an anti-backflow diode; the output terminal of the first solar cell module is connected in series with an anti-backflow diode, the output terminal of the second solar cell module is connected in series with an anti-backflow diode, and the output terminal of the third solar cell module is connected in series with an anti-backflow diode.

optionally, the electronic communication hat also includes:
A control device, located on the inner side of the hat body, electrically connected to the flexible thin-film solar module;
The anti-backflow device may include one or multiple switches, and each sub solar cell module is connected in series with a switch;
The control device can send a first control command to the flexible thin film solar module, and the flexible thin film solar module responds to the first control command to control the opening or closing of the corresponding sub solar cell module switch. There are different options for switches, one is a micro relay, and the preferred one is a dc solid state relay (dc-ssr).

optionally, the electronic communication hat also includes a drive device, located on the inner side of the brim or top of the hat.

flexible thin-film solar module is used to power the driving device; the control device is also used to send a second control instruction to the driving device, and the driving device responds to the second control instruction to perform the corresponding operation; the control device and the driving device can be combined through an integrated circuit chip to form a so-called microprocessor, responsible for identifying, contacting, controlling communication devices used in conjunction with the electronic communication hat, including headphone, walkie talkie, mobile phone, and display glasses.

optionally, the electronic communication hat also includes: a rechargeable battery device, located on the inner side of the hat body; the rechargeable battery device is used to store the electrical energy converted by flexible thin-film solar module, or to supply power to the driving device.

optionally, the driving device includes at least a display glass, a mobile phone, a speaker, a microphone, and a walkie-talkie.

optionally, the electronic communication hat also includes: a buck boost converter located on the inner side of the hat body; the buck boost converter can increase or decrease the voltage of flexible thin-film solar modules.

optionally, flexible thin-film solar module comprises at least one of cadmium telluride solar cells, perovskite solar cells, copper indium gallium selenide solar cells, and organic thin-film solar cells.

optionally, flexible thin-film solar module is made of single solar cells or tandem solar cells.

optionally, the substrate of the flexible thin-film solar module is a flexible transparent polymer substrate, which is located on the outer side of the electronic communication hat and has an inner lining on the inner side of the electronic communication hat; the lining material includes reinforced natural fiber fabric or synthetic fiber fabric.

the material of the flexible transparent polymer substrate includes any one of polyimide, polyethylene naphthalate, and polyethylene terephthalate.

the electronic communication hat provided by the technical solution of the embodiment of the present invention includes: a flexible thin film solar module, the hat top, hat body, and hat brim of the electronic communication hat are all flexible thin film solar modules, the flexible thin film solar module on the hat top is the first solar cell module, the flexible thin film solar module on the hat body is the second solar cell module, and the flexible thin film solar module on the hat brim is the third solar cell module; the first solar cell module, the second solar cell module, and the third solar cell module are connected in parallel circuit; the flexible thin film solar module on the top of the hat includes multiple first zones with the same area, each of which is a sub solar cell module. The multiple sub solar cell modules on the top of the hat are connected in parallel circuit; the flexible thin film solar module of the hat body includes multiple second zones with the same area, each second region being a sub solar cell module, and the multiple sub solar cell modules of the hat body are connected in parallel circuit; the flexible thin film solar module of the brim includes multiple third zones with the same area, each of which is a sub solar cell module. The multiple sub solar cell modules of the brim are connected in parallel circuit; each sub solar cell module includes multiple solar cells, which are connected in series circuit; an anti-backflow device, used to prevent the reverse current conduction of each sub solar cell module. The brim, body, and top of the electronic communication hat in the technical solution of the present embodiment are all made of flexible thin-film solar modules, which can improve the utilization rate of light and battery life; by setting up anti-backflow devices, it is benefited to prevent the reverse current conduction of each sub solar cell module, ensuring the stability and reliability of the electronic communication hat.

it should be understood that the content described in this section is not intended to identify key or important features of the embodiments of the present invention, nor is it intended to limit the scope of the present invention. Other features of the present invention will become easily understood through the following description.

### BRIEF DESCRIPTION OF THE DRAWINGS

in order to provide a clearer explanation of the technical solution in the embodiments of the present invention, a brief introduction will be given to the drawings required for the description of the embodiments. It is obvious that the drawings described below are only some embodiments of the present invention. For those skilled in the art, other drawings can be obtained based on these drawings without creative labor.

FIG. 1 is a schematic diagram of the structure of an electronic communication hat provided in an embodiment of the present invention.

FIG. 2 is a schematic diagram of the brim structure of an electronic communication hat provided in an embodiment of the present invention.

FIG. 3 is a schematic diagram of the hat body structure of an electronic communication hat provided in an embodiment of the present invention.

FIG. 4 is a schematic diagram of the hat top structure of an electronic communication hat provided in an embodiment of the present invention.

FIG. 5 is a schematic circuit diagram of a hat brim provided in an embodiment of the present invention.

FIG. 6 is a schematic circuit diagram of a hat body provided in an embodiment of the present invention.

FIG. 7 is a schematic circuit diagram of a hat top provided in an embodiment of the present invention.

FIG. 8 is a schematic circuit diagram of an electronic communication hat provided in an embodiment of the present invention.

FIG. 9 is a schematic diagram of the structure of another electronic communication hat provided by an embodiment of the present invention.

FIG. 10 is a logic control diagram of an electronic communication hat provided in an embodiment of the present invention.

### DETAIL DESCRIPTION

in order to enable personnel in this technical field to better understand the solution of the present invention, the following will provide a clear and complete description of the technical solution in the embodiments of the present invention in conjunction with the accompanying drawings. Obviously, the embodiments are only a part of the embodiments of the present invention, not all of them. Based on the embodiments of the present invention, all other embodiments obtained by ordinary skilled people in the art without creative labor should fall within the scope of protection of the present invention.

it should be noted that the terms “first”, “second”, etc. In the present invention are used to distinguish similar objects and do not necessarily describe a specific order or sequence. It should be understood that the data used in this way can be interchanged in appropriate circumstances, so that the embodiments of the present invention described herein can be implemented in order other than those illustrated or described herein. In addition, the terms “including” and “having” and any variations thereof are intended to cover non-exclusive inclusions, such as processes, methods, systems, products, or devices that contain a series of steps or units that are not necessarily limited to those clearly listed, but may include other steps or units that are not clearly listed or inherent to these processes, methods, products, or devices.

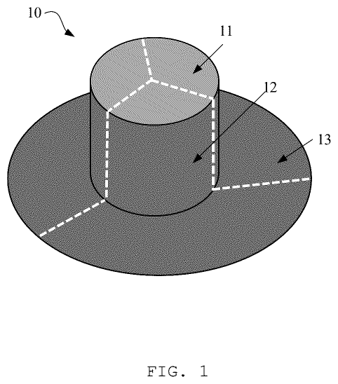

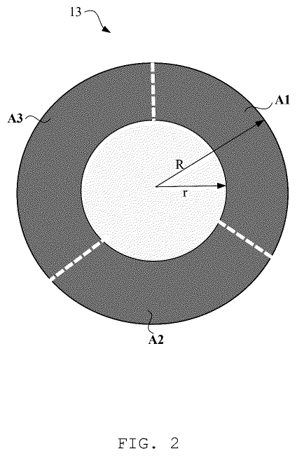

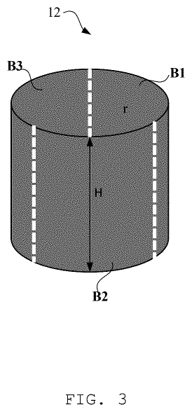

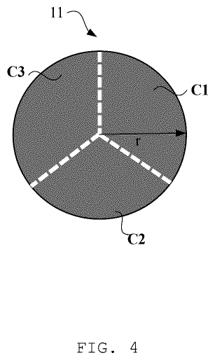

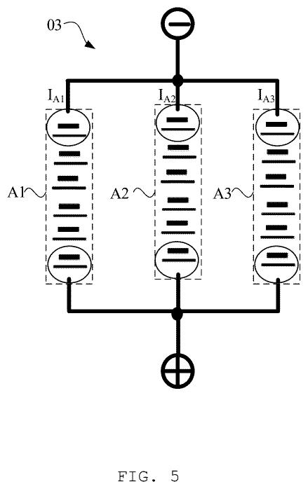

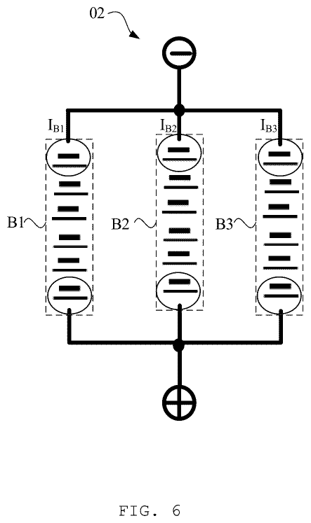

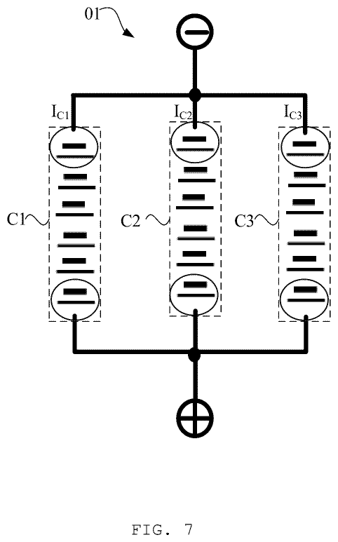

an embodiment of the present invention provides an electronic communication hat. FIG. 1 is a schematic diagram of the structure of an electronic communication hat provided by an embodiment of the present invention. FIG. 2 is a schematic diagram of the hat brim structure of an electronic communication hat provided by an embodiment of the present invention. FIG. 3 is a schematic diagram of the hat body structure of an electronic communication hat provided by an embodiment of the present invention. FIG. 4 is a schematic diagram of the hat top structure of an electronic communication hat provided by an embodiment of the present invention. FIG. 5 is a schematic diagram of the circuit of the hat brim provided by an embodiment of the present invention. FIG. 6 is a schematic diagram of the circuit of the hat body provided by an embodiment of the present invention. FIG. 7 is a schematic diagram of the circuit of the hat top provided by an embodiment of the present invention. 8 is a circuit schematic diagram of an electronic communication hat provided in an embodiment of the present invention. Referring to FIGS. 1-8, the electronic communication hat comprises: a flexible thin film solar module 10, the top 11, body 12, and brim 13 of the electronic communication hat are all flexible thin-film solar cells. The flexible thin-film solar module on the top 11 is the first solar cell module 01, the flexible thin-film solar module on the body 12 is the second solar cell module 02, and the flexible thin-film solar module on the brim 13 is the third solar cell module 03; the first solar cell module 01, the second solar cell module 02, and the third solar cell module 03 are connected in parallel circuit.

the flexible thin film solar module of the hat top 11 includes multiple first zones with the same area, each of which is a sub solar cell module. The multiple sub solar cell modules of the hat top 11 are connected in parallel circuit; the flexible thin film solar module of the hat body 12 includes multiple second zones with the same area, each second zone being a sub solar cell module, and the multiple sub solar cell modules of the hat body 12 are connected by a parallel circuit; the flexible thin film solar module of the brim 13 includes multiple third zones with the same area, each of which is a sub solar cell module. The multiple sub solar cell modules of the brim 13 are connected in parallel circuit; each sub solar cell module includes multiple solar cells, where the number of solar cells can be m, depending on the open circuit voltage of the flexible thin film solar cell and the working voltage determined by the electronic communication hat product. The value of m can be 2-20 solar cells, and those solar cells are connected in series circuit; anti-backflow device is used to prevent the reverse current conduction of each sub solar cell module.

among them, the electronic communication hat of the present invention refers to a head wearable device, and the hat itself is preferably in a shape with a large exposure area, including but not limited to a top hat, sun hat, baseball long tongue hat, degree hat, police top hat, gentleman's top hat, round top hard hat, cowboy hat, bucket hat, mexico wide brimmed hat, sun protection wide brimmed hat, and hats that can increase surface area such as christmas hat, witch hat, etc. Among them, the long-brimmed baseball cap has the smallest illumination area, which is about 200 cm² based on a hat body diameter of 20 cm, and other types of hats are significantly larger than 200 cm²; in order to achieve a sufficiently large area to generate sufficient photocurrent or power, the present invention is not limited to the above types of hats, and can completely adopt local enlargement, elevation, or additional suitable shoulder or back shoulder cloaks to increase the photovoltaic power generation area. Its exterior is composed of flexible thin-film solar module 10; the interior of the electronic communication hat adopts multi-zone sub-solar cell modules in series and parallel connection and intelligent management by switch, diode, or others, and the inner side of the electronic communication hat can be reinforced with natural or synthetic fiber fabric to increase comfort, aesthetics, or durability. The internal and external design meets the requirements of soft and breathable wearing, adjustable size of fastening accessories according to the head shape, easy cleaning, and strong for durability; the flexible thin-film solar module 10 of the electronic communication hat has an output connection port, and its photoelectric energy conversion efficiency pce is greater than 22% under standard am 1.5 g spectral illumination.

the electronic communication hat of the present invention belongs to wearable electronic devices, and the hat body must meet the functional requirements and durability, while also satisfying the lightweight, thin, water-proof, and flexible elements suitable for the human body as much as possible, while ensuring sufficient photovoltaic power generation function within the limited outer surface area of the hat. For example, generating enough photovoltaic power to support a mobile phone under moderate sunlight, a pair of display glasses with sufficient brightness to carry a camera function (maximum brightness 1000-5000 nits), two high-power speakers and microphones (maximum power 5 watts) for simultaneous use.

the flexible thin film solar module of the electronic communication hat is composed of a hat top, a hat body, and a hat brim, each of which is further composed of at least 2-8 zones for fine zoning management in case of uneven light-generating current upon different zones so as to provide more stable power supply for any communication apparatus assembled. In FIGS. 1-8, the electronic communication hat can be a dome hat, with dimensions and decorations suitable for men, women, and children of all ages. Such a hat consists of a dome, a cylindrical hat body, and a brim. The outer surface area of the top hat with the dome diameter of 20 cm, the hat body height of 15 cm, and the brim width of 10 cm is approximately 1570 cm². considering that the solar illumination intensity on a typical cloudy day is 2500 lux, or 300 w/m², and the power consumption of a typical mobile phone is 5 watts, and the hat surface receives about 50% of the light, it is required that the energy conversion efficiency of the photovoltaic module be greater than 22%; select a flexible thin-film solar module round block with a suitable diameter as the hat top 11; a rectangular flexible thin-film solar module is enclosed in a hat body 12; a circular flexible thin film solar module is used as the brim 13, and the brim 13, body 12, and top 11 of the hat are all flexible thin film solar modules. The electronic communication hat formed by this way is covered entirely with photovoltaic devices, which can improve the utilization rate of light to generate photovoltaic power and to achieve stable and endurance driving communication devices.

for the round-shaped hats in FIGS. 1-8, the reasonable lighting area, overall voltage, and current requirements of the electronic communication hat can be achieved through series and parallel connections. The electronic communication hat can be made according to the design of the hat for flexible thin-film solar modules. For efficient output of power from the flexible thin film solar module around the hat, firstly the hat is divided into the brim 13 which is further divided into three third zones, namely a1, a2, and a3, with equal areas; secondly, the hat body 12 is divided into three second zones, namely b1, b2, and b3, with the same area; thirdly, the hat top 11 is divided into three first zones, namely c1, c2, and c3, with the same area.

in the embodiment of the present invention, the electronic communication hat is divided into multiple regions according to the brim 13, body 12, and top 11 for series and parallel connection of solar cells. The electronic communication hat can be divided into a top, body, and brim, and the top can include three first zones, each of which is a sub solar cell module. The three sub solar cell modules are connected by a parallel circuit, and each sub solar cell module is composed of six solar cells connected in series; the hat body can include three second zones, each of which is a sub solar cell module. The three sub solar cell modules are connected in parallel, and each sub solar cell module is composed of six solar cells connected in series; the hat top can include three third zones, each of which is a sub solar cell module. The three sub solar cell modules are connected in parallel, and each sub solar cell module is composed of six solar cells connected in series; afterwards, each region is connected to the output port or power supply port through parallel circuits for operation. According to the principle of equal division, a sub solar module can be divided every 20 degrees at the brim 13, body 12, and top 11 of the hat. Six solar cells form a sub solar cell module every 120 degrees, and each sub solar cell module is composed of six solar cells connected in series. Here solar cells are the core components that convert sunlight into electricity, and a solar module is also known as a photovoltaic (pv) module or solar panel which is composed of multiple solar cells connected together in series or parallel configurations. Flexible thin-film solar module comprises either single solar cells or multi cell stacked (so called tandem) solar cells. A single solar cell is defined here as each cell containing only one p-n semiconductor junction, while a tandem solar cell is defined as each cell containing multiple stacked p-n semiconductor junctions. Obviously, a tandem solar cell comprises more layers and thus outputs more voltage and greater efficiency.

for example, the embodiments of the present invention adopt flexible perovskite solar cells, with an energy conversion efficiency pce of 23% under standard illumination spectrum conditions and its unit area power of 230 w/m2 as raw materials to form the hat solar module. The process steps for producing photovoltaic hats are described below:

making a hat top: obtain a circular flexible solar module with a diameter of 20.3 cm as a dome. According to the principle of equal division, divide a solar cell every 20 degrees on the circular hat top. Connect every 6 solar cells in the series to form a sub solar cell module and form a sub solar cell module every 120 degrees of arc. After subtracting the area loss caused by the adhesive of the final product, its effective area is s1=πr²=3.14·10²=314 cm².

making a hat body: the prefabricated hat body flexible photovoltaic panel is a rectangular shape with a length of l=2πr=62.8 cm and a height of h=19.5 cm. It is divided into sub solar cells every 20 degrees, and every 6 solar cells are connected in series to form a sub solar cell module, or every 120 degrees of arc to form a sub solar cell module; a rectangular shape is used to enclose the hat body, and the edges are fixed with glue and sewn for reinforcement; its effective area s2=2πrh=2·3.14·19=1193 cm².

making brim: prefabricated brim of flexible photovoltaic panel forms a ring with an outer diameter of 2r=38 cm and an inner diameter of 2r=20 cm, dividing a solar cell every 20 degrees, connecting 6 solar cells in series to form a sub solar cell module, or forming a sub solar cell module every 120 degrees of arc; its effective area is s3=πr²−πr²=819 cm².

assemble electronic communication hat: use bisphenol a adhesive to bond the circular disc of the hat top and the cylinder composed of the hat body, and bind the hat body with the hat brim, connect the hat top, hat body, and hat brim, and finally use fishing line to sew and strengthen the fastness of the hat.

connect the lead wires to the output port: connect the reserved male and female wires of the hat top, hat body, and hat brim into the whole hat solar module, and export the positive and negative poles of the flexible thin-film solar module to the usb-type c connector.

installation of flexible photovoltaic hat lining: use breathable, sturdy natural thin woolen fabric, reinforced natural fiber fabric or synthetic fiber fabric as the lining, and use universal glue to bond together, use fishing thread to enhance firmness and wearing comfort of the electronic communication hat. An adjustable fastening inner ring can be installed in the lining, suitable for adjusting tightness for different head shape of different personnel.

shaping: use steam hot pressing technology to place the hat into a shaping mold, control the mold at 80 degrees celsius for about 20 minutes to firm the hat shape, and ensure that the shape meets the design requirements.

the total area of the hat prepared from the above is 2326 cm², and the theoretical maximum power is 0.2326×230=53 w (according to 1000 w/m² illumination). The actual test showed that the vertical irradiation area (usually at noon time) was 1133.5 cm², the maximum power was 0.1133·230=26 w (based on 1000 w/m² illumination), the open circuit voltage v_{oc} was 6.5v, and the short-circuit current i_{sc} was 4.0a; under cloudy weather, the maximum power tested was 115·(0.2326/2)=13 w, v_{oc}=6.5 v, i_{sc}=2.0 a when the diffuse illumination was halved to 500 w/m². in the comparative case with the same size hat was used as the solar module wherein commercially optimal monocrystalline silicon solar cells used. Although its energy conversion efficiency can reach pce=23%, it cannot be made into flexible photovoltaic panels and can only be made into rectangular and circular blocks. The effective area of the hat photovoltaic panel was discounted by 80%. In actual testing, the vertical irradiation area at noon was 80%1133.5 cm², the maximum power was 0.8·0.1133·230=20.8w (under 1000 w/m² illumination), the open circuit voltage v_{oc} was 5.2v, and the short-circuit current i_{sc} was 2.08a. The maximum power tested at scattered illumination is halved to 500 w/m² in cloudy weather; thus tested output power=5.2 w, v_{oc}=5.2v, i_{sc}=1.0a. Therefore, using monocrystal si solar module can hardly meet with efficient photovoltaic conversion into appreciable electricity power.

in another embodiment of the technology, the outer diameter r of the brim 13 is 19 cm, the outer radius r of the hat body 12 is 10 cm, and the height is h=19 cm. The total area of the brim 13 is a=π(r²−r²)=3.14·(192−102)=819 cm², the area a1=a2=a3=273 cm² for the three first zones, the total area b=2π rh=2·3.14×19.19=1193 cm² for the hat body 12, and the area b1=b2=b3=397 cm² for the three second zones; the total area of hat top 11 is c=πr²=3.14·10²=314 cm², and the area of the three third zones is c1=c2=c3=104 cm²; in the flexible thin-film solar module shown in FIGS. 1-8, the maximum power voltage vₘₚ of each solar cell is 1.0v, and the maximum power current density jₘₚ is 24 ma/cm². ideally, the output voltage v13=v12=v11=6×1v=6v for the brim 13, body 12, and top 11 of the hat, the output current i₁₃=iₐ₁+iₐ₂+iₐ₃=24×(a1+a2+a3)=6552+6552+6552=19656 ma; i₁₂=i_{b1}+i_{b2}+i_{b3}=24×(b1+b2+b3)=9528+9528+9528=28584 ma; i₁₁=i_{c1}+i_{c2}+i_{c3}=24×(c1+c2+c3)=2496+2496+2496=7488 ma; the brim 13, body 12, and top 11 of the hat are connected into a usb type c as the output terminal for the flexible thin-film solar cell through a parallel circuit.

according to the flexible perovskite solar module used in the present invention, its energy conversion efficiency under standard illumination spectrum conditions is currently the best in the industry. The power-conversion efficiency (pce) of a single segment solar cell is 26%, and the power per unit area is 260 w/m² as raw material for the hat solar module. The overall top hat area is 2577 cm², and the theoretical maximum power is 0.2577×260=67 w (based on 1000 w/m² illumination); the maximum power measured under scattered illumination of 250 w/m² in a cloudy or overcast weather is 8.0 W, v_{oc}=10v, i_{sc}=0.8a. It can fully meet the requirements of a mobile phone and display glasses.

under indoor lighting condition, the laboratory and operating room are illuminated at 1000-5000 lux, while other indoor sites such as shopping malls typically have an illumination of 500-1000 lux. Under indoor led illumination (1000 lux, 4000k, 10 w/m²), the theoretical maximum power is 0.26×0.2577 m²×10 w/m²=0.67 w (according to simulated solar spectrum). The actual measured peak voltage of the photovoltaic hat is v=10 v, the current density is 150 ma, and the power is 10×0.15=1.1 w, indicating that perovskite thin film solar module has good enough photovoltaic power due to its super absorption led emission spectrum performance. Thus, it can meet with the power consumption of general voice communication for a mobile phone. Comparative case: for the same size hat, using commercially optimal monocrystalline silicon as the photovoltaic module, the energy conversion efficiency can reach pce=23%. However, due to the inability to make flexible photovoltaic panels, only hat brim and hat top circular disc can be used. The effective area of the hat photovoltaic panel is discounted by 80%. The actual test showed that under the vertical irradiation at noon was 80%·0.2577·260=53.6 w/cm², and the maximum power measured under scattered illumination of 250 w/m² in cloudy weather was 5 w, v_{oc}=5.2v, i_{sc}=0.96a. Under indoor led illumination (1000 lux, 4000 k, 10 w/m²), the theoretical maximum power is 0.23·0.2577 m²·10 w/m²=0.59 w (according to simulated solar spectrum). The actual measured peak voltage of the photovoltaic hat is v=10v, and the current density is only 20 ma, thus the power is 10·0.02=0.2 w; it can hardly meet the effective power supply function for a mobile phone.

considering that the photovoltaic current generated by electronic communication hat varies in different situations under different scenarios such as slanting sunlight in the morning and evening, overhead lighting at noon, and scattered light in cloudy or indoor environments, users are likely to move continuously under sunlight and change between sunny and dark zones at any time. When the photovoltaic current generated at a certain moment is significantly lower than the required value, the dark zones (non-power generating zones) of the hat can consume the current generated in the sunny zones (power generating area), and in severe cases, they may even be damaged by reverse current. In this embodiment of the present invention, an anti-backflow device is installed in each zone of the flexible thin film solar module to prevent reverse current conduction, ensuring the power supply stability of the hat solar module as well as better effectiveness of the electronic communication hat.

the electronic communication hat provided by the technical solution of the present embodiment includes: a flexible thin film solar module 10 comprising a hat top 11, a hat body 12, and a hat brim 13, all of which are flexible thin film solar modules. The flexible thin film solar module of the hat top 11 is the first solar cell module 01, the flexible thin film solar module of the hat body 12 is the second solar cell module 02, and the flexible thin film solar module of the hat brim 13 is the third solar cell module 03; the first solar cell module 01, the second solar cell module 02, and the third solar cell module 03 are connected in parallel circuit; the flexible thin film solar module of the hat top 11 includes multiple first zones with the same area, each of which is a sub solar cell module. The multiple sub solar cell modules of the hat top 11 are connected in parallel circuit; the flexible thin film solar module of the hat body 12, similarly includes multiple second zones with the same area, each second region being a sub solar cell module, and the multiple sub solar cell modules of the hat body 12 are connected by a parallel circuit; the flexible thin film solar module of the brim 13, similarly includes multiple third zones with the same area, each of which is a sub solar cell module. The multiple sub solar cell modules of the brim 13 are connected in parallel circuit; each sub solar cell module includes multiple solar cells, which are connected in series circuit; an anti-backflow device is connected with each sub solar module in parallel circuit, used to prevent reverse current conduction of each sub solar cell module, and the anti-backflow device can be a reverse current or reverse power protection device. The brim 13, body 12, and top 11 of the electronic communication hat in the technical solution of the present embodiment are all flexible thin-film solar modules, which can improve the utilization rate of light and solar module life; by setting up anti-backflow devices, it is possible to prevent the reverse current conduction of each sub solar cell module, ensuring the power supply stability reliability of the electronic communication hat.

optionally, multiple anti-backflow diodes are used, with blocking diodes being the preferred choice for achieving forward conduction and reverse cut-off; the output terminal of each sub solar cell module is connected in series with an anti-reverse diode; the output terminal of the first solar cell module is connected in series with an anti-reverse diode, the output terminal of the second solar cell module is connected in series with an anti-reverse diode, and the output terminal of the third solar cell module is connected in series with an anti-reverse diode.

among them, the output terminal of each sub solar cell module is connected in series with an anti-reverse diode, which can avoid reverse current conduction of each sub solar cell module; the output terminal of the first solar cell module is connected in series with an anti-reverse diode, the output terminal of the second solar cell module is connected in series with an anti-reverse diode, and the output terminal of the third solar cell module is connected in series with an anti-reverse diode, which can avoid the directional current conduction of the first solar cell module, the second solar cell module, and the third solar cell module, thereby avoiding the reverse current conduction of each sub solar cell module and ensuring the stability of the electronic communication hat.

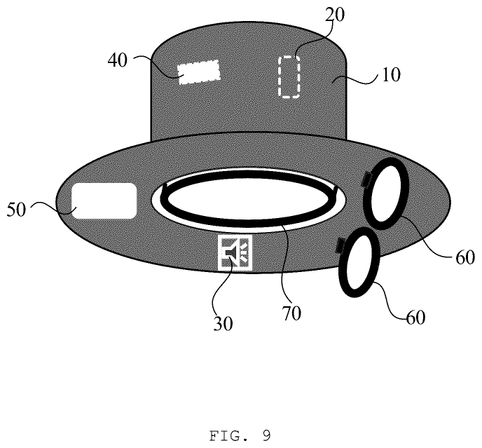

optionally, FIG. 9 is a schematic diagram of the structure of another electronic communication hat provided by an embodiment of the present invention. Referring to FIG. 9, the electronic communication hat further comprises: a control device 40, which is located on the inner side of the hat body and is electrically connected to the flexible thin film solar module 10; the anti-backflow device includes multiple switches, and each sub solar cell module is connected in series with a switch; the control device 40 is used to send a first control command to the flexible thin film solar module 10, and the flexible thin film solar module 10 responds to the first control command to control the opening or closing of the corresponding sub solar cell module switch. There are different options for switches, one is a micro relay, and the preferred one is a dc solid state relay (dc-ssr).

among them, the hat body in FIG. 9 also includes the wiring of sub solar cell modules in different zones, as well as the suitable inner lining and output interface of flexible thin-film solar modules for wearing; the control device 40 can be a microprocessor, which can include any one of a power intelligent controller bmd, a programmable logic controller (plc) or a driver chip; the control device 40 also includes a management driver chip module that automatically manages the charging and discharging of flexible thin-film solar modules; turn on the phone, display glasses, manage the charging and discharging of flexible thin-film solar modules, and select audio, video, and function menus.

when designing an electronic communication hat, due to the possibility of the user wearing with the electronic communication hat may be moving continuously in sunlight and in shade, the photovoltaic current generated at a certain zone module is significantly lower than the other zones, and the system should automatically shut down the line to avoid the dark zone (non-power generating area) solar module consuming the current generated in the sunlight zones (power generating area), and even to prevent reverse current damage in severe cases. One way is to use a simple diode, such as an anti-reverse diode in the series connection of each sub solar cell module to prevent reverse current conduction. Another way is to use a programmable logic controller (plc) or driver chip in the hat body, configure input and output modules in the plc, connect switches and control signals in each area, and automatically control switches in different zones based on preset logic and real-time data. In the embodiments of the present invention, when using a driving chip, input/output modules can be configured in the driving chip, multiple switches of the anti-backflow device can be connected, and multiple control signals can be transmitted to the anti-backflow device. According to preset logic and real-time data, switches at different positions can be automatically controlled to avoid damage caused by reverse current; alternatively, when using the power intelligent controller bmd, it can be connected to the central monitoring system of the microcontroller (central process unit, cpu), in conjunction with the built-in control chip in the cpu and combined with prefabricated algorithms and automatic voltage current control. The control chip of the cpu automatically controls the switches in different zones based on preset logic or real-time data. For example, under noon sunlight, multiple first zones of the hat top and multiple third zones of the hat brim generate mainstream photovoltaic electricity, while multiple second zones of the hat body have no photovoltaic effect; when the sunlight is slanting, the light facing surface of the electronic communication hat includes the top, body, and brim of the hat. The light facing side generates mainstream photovoltaic electricity, and the control device recognizes and opens the corresponding sub solar cell module switch. However, the photovoltaic current generated on the backlight surface is low, and the control device recognizes and disconnects the corresponding sub solar cell module switch, thereby avoiding each sub solar cell module from becoming a resistive load and avoid consuming electricity or even damaged by reverse current.

the top, body, and brim of the electronic communication hat generate different photovoltaic currents in different zones under different lighting scenarios such as slanting sunlight in the morning and evening, overhead sunlight at noon, and scattered light in cloudy or indoor areas. Especially in dark zones where the photovoltaic current is low, it is necessary to automatically turn off its function, otherwise the electricity generated in zones with high photovoltaic current will be consumed due to the series constant current effect. By dividing the top, body, and brim of the hat into multiple zones and controlling the conduction and disconnection of each zone, the overall efficiency of the electronic communication hat can be improved by optimizing power flow and enhancing its stability during use; and the partition control or zone control can quickly isolate the faulty area in case of a fault, avoiding the fault from spreading to the entire device. Therefore, in the use of electronic communication hat, especially when users wearing the hat are moving to different environments, controlling the connection and disconnection of multiple zones can improve the stability of the entire system.

the partition control described in the present invention can divide the top, body, and brim of the electronic communication hat into multiple zones, each of which can be independently controlled and optimized. The partition control design can improve the overall power supply stability and reliability, enabling it to cope with different operating conditions and demand changes. Partition connection and disconnection control significantly improves the overall efficiency of flexible thin-film solar modules in the hat by optimizing power flow, improving equipment stability, optimizing energy utilization, and enhancing equipment flexibility.

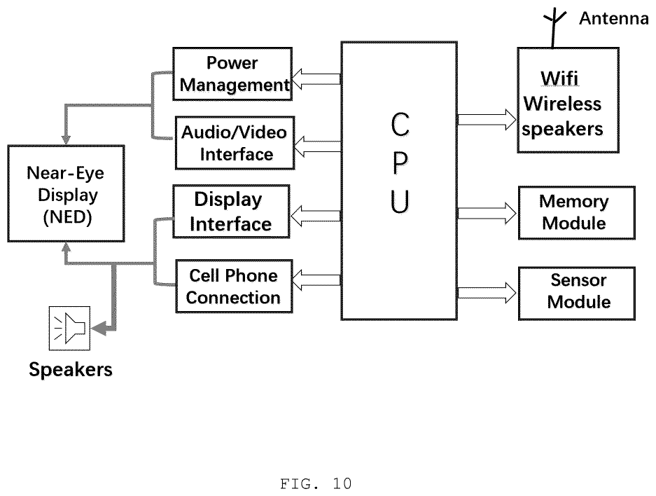

optionally, the electronic communication hat also includes a driving device, whose circuit is typically composed of one or more power metal oxide semiconductor field-effect transistors (mosfets). When the driving circuit receives a control signal, the mosfets conduct, allowing the current in the load circuit to pass through. The driving device is located on the inner side of the brim or top of the hat. Flexible thin-film solar cell 10 is used to power the driving device; the control device 40 is also used to send a second control instruction to the driving device, and the driving device responds to the second control instruction to perform the corresponding operation. Obviously, the control device and the driving device can be combined through an integrated circuit chip to form a so-called microprocessor (as shown in FIG. 10) cpu.

among them, the microprocessor cpu in FIG. 10 is responsible for identifying, contacting, controlling and communicating with the communication devices used in conjunction with the electronic communication hat, including the display glasses 60, mobile phone 50, and speaker 30 shown in FIG. 9; the position of mobile phone 50 needs to be equipped with a mobile phone plug-in pocket for fixing the phone, which can be connected to the phone through wired or wireless connection for use; two display glasses 60 can be set, corresponding to the left and right eyes respectively. The display glasses 60 are installed inside the communication hat brim through a pivot, and both are foldable display glasses. An inner lining 70 is also installed inside the electronic communication hat, which can be reinforced with natural or synthetic fiber fabric to increase comfort, aesthetics, or durability, making it more comfortable to wear and also protecting the control device 40 or microprocessor installed in the hat body. The control device can drive the driving device separately and can control any driving device according to demand. The control instructions include but are not limited to opening, closing, displaying menus, switching audio and video, etc.

for example, the driving device service in the embodiment of the present invention includes a mobile phone, which can be equipped with at least one plug-in pocket on the inner rear of the brim or the inner side of the top of the hat, at least one personal smartphone can be placed, and the phone's charging and discharging, audio and video interfaces can be configured. At present, most smartphones have dimensions of 75×160×9 mm in length, width, and thickness, and can use a universal usb type-c multifunctional interface to meet the requirements of current and audio/video connection and transmission. The usb type-c output interface is no longer limited to charging, discharging, and data transfer functions, but also includes video output, audio output, and multifunctional docking stations. Multi-functional docking stations include displays, keyboards, storage devices, artificial intelligence, etc. When the mobile phone is connected to the electronic communication hat in the present invention through usb type-c, the electronic communication hat is controlled by the control device 40, and key functions of the mobile phone can be transferred to the electronic communication hat, so that all normal telephone functions can be used.

currently, smartphones consume different amounts of power and energy depending on their usage scenarios. For example, in standby mode, the main purpose is to maintain network connectivity, requiring only 0.1-0.5 watts; 2-4 watts are required when using screens and mild processors for social media travel; when watching videos or browsing web pages, a screen and gpu load of 4-8 watts are required; when playing high frame rate games, recording videos, and navigating, a work screen is required that also need cpu, gpu, gps to work, and the overall 6-10 watts are required. Obviously, shrinking the phone screen or not using the phone screen is a way to save power without affecting its functionality. The electronic communication hat of the present invention is compatible with existing smartphones on one hand. The technical approach adopted is to design a mobile phone pocket inside the electronic communication hat, and the mobile phone can be connected using a data cable or wireless connection to the communication hat. Control device 40 in the electronic communication hat is used to control and transfer the display screen of the mobile phone to the display glasses 60. transfer the audio from the phone to the speaker and microphone of the electronic communication hat. Due to the shortening of the distance between the display glasses and the eyes, the distance between the speaker and microphone and the user's ears and mouth is reduced, which can achieve better audio and display effects, better sound quality enjoyment, and better sound propagation. In addition, due to the reduction in size and distance with the use of display glasses, display power consumption has also been reduced greatly.

for example, the driving device service in the embodiment of the present invention includes display glasses, and the display glasses in the embodiment of the present invention include 1-2 near eye display glasses. Near eye display (ned) is a technology that presents images or information directly to the user's eyes, widely used in augmented reality (ar), virtual reality (vr), and mixed reality (mr) devices. At present, near eye displays typically use nail sized micro displays such as light-emitting diode (led) displays, organic light-emitting diode (oled) displays, liquid crystal displays (lcd), or liquid crystal on silicon (lcos) displays, which all have high resolution (4k) and high refresh rate to ensure clear and smooth images. In addition, micro displays project images onto the user's retina or eyeglass lenses through optical systems, forming virtual images; using optical systems to magnify and project the image of the display onto the user's field of view through components such as lenses or waveguides. This type of optical projection has the advantage of power saving, but the design needs to be precise to ensure the clarity and field of view of the image. The embodiments of the present invention can be any type of near-eye display, which can be set according to actual needs. Considering fine display quality, and energy saving, the present invention prefers oled or led micro display glasses, which can provide an immersive visual experience, even semitransparent display, making users feel as if they are in a virtual environment or augmented reality scene.

place 1 or 2 display glasses at the corresponding positions inside the brim of the hat, and users have freedom to choose between binocular display, monocular display, and non-display modes by mechanically flipping them. Under binocular display, different images are displayed through the left and right eyes attached to the video source to achieve stereoscopic and 3d effects, as well as augmented reality and virtual reality applications. Under monocular display, while one eye observes the environment, the other eye can view the content of the display, including images, videos, text, etc., which can achieve excellent enhancement of virtual and real sense. In addition, switching between left and right eyes can also alleviate eye fatigue.

near eye displays typically integrate multiple sensors such as gyroscopes, accelerometers, and eye tracking sensors to track user head and eye movements, resulting in a more natural interactive experience and autofocus functionality. Micro cameras can be installed on the edges of the micro display glasses to enable photography and videography functions. At the same time, through depth sensors, user gestures can be recognized to achieve a more intuitive gesture interaction method, controlling the switch of videography from smart phone and videography from reality. Near eye display has been widely applied in ar, vr, and xr glasses, with weights ranging from 20 grams to 100 grams. The frame of the micro display glasses can be equipped with speakers for voice control, allowing the wearer to hear sound or music. The display glasses in the embodiments of the present invention are integrated on the electronic communication hat brim, which can avoid the discomfort caused by the need to bear weight on the eye sockets, nose bridge, and cheeks when wearing glasses, and this brings the advantage of significantly improving existing ar, vr, and xr glasses. In addition, the flexible thin film solar module 10 of the present invention has photovoltaic power generation function to supply power for the communication hat installed with audio and or video. Furthermore, the communication hat can also be equipped with charging and discharging devices on the hat body. Combined with the built-in rechargeable battery of the mobile phone itself, the advantages of providing electricity from these three aspects fully overcome the battery runtime problems of previous vr, ar, and xr, walkie-talkie, mobile phone, etc. Besides, the present invented communication hat can greatly reduce display page latency, improve refresh rate, reduce dizziness and enhance user experience, thereby providing high-quality visual experience and natural interaction mode for near eye display technology, and playing an increasingly important role in virtual reality, augmented reality, mixed reality and other fields.

optionally, referring to FIG. 9, the electronic communication hat further comprises: a charging and discharging device 20 located on the inner side of the hat body; the charging and discharging device 20 is used to store the electrical energy converted by the flexible thin-film solar module 10, or the charging and discharging device 20 directly supplies power to the driving device.

among them, the charging and discharging device 20 can be a rechargeable battery, preferably a lithium-ion secondary battery. When the flexible thin-film solar module 10 in the dark area cannot provide power, the battery 20 provides power for the driving device. And when exposed to sunlight, the flexible thin-film solar module 10 can charge the battery device 20, meaning that the charging battery being used to store electricity generated by the solar cell hat. Supposed the driving device is a mobile phone, the first priority for its operation and control is to use flexible thin-film solar module 10 for power. When the power generation is insufficient, the second priority is to use the battery device 20; and the final priority is to use the mobile phone battery to ensure the optimal power endurance of the overall electronic communication hat. The rechargeable device 20 is preferably a lithium-ion secondary battery with a suitable capacity of 5000-20000 mah, it can be charged outdoors in sunny weather, and the charging level is generally set between 0.2-1.0 c (c is the battery capacity); and the power consumption of connecting mobile phones, displays, etc. Under weak indoor lighting intensity. Under extreme conditions, such as at night, all flexible thin-film solar module 10 turn off power and the rechargeable devices 20 plays role. When there is sufficient sunlight outdoors, the flexible thin-film solar module 10 in the electronic communication hat generates a photovoltaic current greater than the usage current or electrical energy, and the excess photovoltaic electricity is automatically stored by the rechargeable device 20 until it is fully charged.

optionally, the driving device in the microprocessor includes at least one display glass, a mobile phone, a speaker, a microphone, and or a walkie-talkie.

among them, at least one headphone speaker and one microphone can be installed on the left and/or the right side of the brim of the electronic communication hat, and the power of both the speaker and microphone should not be less than 5 watts. A plug-in pocket can be installed on the inner back of the brim or the top of the inner side of the hat for easy placement of a personal smartphone and equipped with power and bluetooth headphone connectivity functions. The hat body contains a rechargeable battery device, preferably a lithium-ion secondary battery, with a charging and discharging capacity of greater than or equal to lah, preferably 2-10 ah, and is equipped with power management charging and discharging functions. The inner side of the front brim of the hat can optionally install 1-2 foldable micro display glasses, which can be flipped down or up to achieve near eye viewing with or without video, text, or images, and can be used alternately by the left and right eyes or in a resting mode. Micro display glasses should have a pixel resolution of at least 4k and a brightness of no less than 2000 nits. They can also be equipped with camera, photography, and sound amplification functions, and are equipped with driver chips for near eye display control. The hat can optionally include a microprocessor, management driver chip and control device, automated communication and collaboration intercom function for communication devices, such as mobile phone, display glasses, flexible thin film solar cell charging and discharging, audio, video, and function menu selection; its computing and image processing capabilities support at least 4k display resolution and 60 fps high frame rate.

for example, the driving device in the embodiments of the present invention includes a multi speaker, or a walkie talkie, and both walkie talkie and mobile phone are devices that transmit voice through wireless signals. Both walkie talkie and mobile phone use microphones to convert voice signals into electrical signals (audio signals), except that walkie talkie typically uses vhf or uhf frequency bands, while mobile phone uses cellular network frequency bands (such as gsm, cdma, 4 g, 5 g, etc.). Obviously, the signal processing of walkie talkies is relatively simple, and their functions can be achieved by performing analog or simple digital modulation; the walkie talkie adopts a simplex communication mode, implementing point-to-point or point-to-multipoint communication. Its communication distance is limited (usually within a few kilometers), and it consumes a large amount of power, usually 1-5 watts; the characteristic of walkie talkie communication is that it does not require base station support and is transmitted directly through radio waves. Therefore, in some special occasions, especially in mountainous areas, mining areas, or in case the cellular network frequency bands (such as gsm, cdma, 4 g, 5 g, etc.) That mobile communication relies on do not work, walkie talkie is widely used in public safety, construction sites, logistics transportation, leisure activities, and other scenarios. Walkie-talkies are suitable for short distance instant communication with multiple people, as well as for situations that require fast communication and coordination, such as police, fire, emergency, etc., to provide timely and effective communication functions. The embodiments of the present invention may include a walkie talkie using vhf or uhf frequency bands, which facilitates communication among multiple family members traveling in mountainous areas or facilitates special use by small teams such as mountaineers and soldiers conducting field exercises in border areas.

the electronic communication hat provided in the embodiment of the present invention can be equipped with a lithium battery with a capacity of 5000 mah inside its hat body. Two micro earphones on the left and right sides are installed on the outer surface of the inner lining, and it also has an intercom microphone function. The earphone microphone requires a power of 5 watts and is installed inside the hat top, so that the earphone microphone has an intercom control chip and a simple high-frequency vhf or ultra-high frequency uhf transmission function for signal transmission and reception. Optionally, it is useful to make a hole in the center of the hat top to facilitate a 1 cm long antenna on the outside of the hat for intercom function. The earphones are equipped with control switches or vibration switches, such as “twice tapping” for listening, “one tapping” for speaking, and the manual button as the switch on and off.

the microphone in the hat body and the headphone speaker has intercom function. The flexible thin-film solar module and rechargeable battery in the electronic communication hat can precisely meet the requirement of transmitting and receiving wireless signals for intercom functions, and the battery life can be easily over 8 hours.

Compared with the battery life of general civilian intercoms, which is less than 3 hours, the embodiment of the present invention therefore improves the battery runtime of intercoms.

FIG. 10 is a logic control diagram of an electronic communication hat provided in an embodiment of the present invention, in which the core function of the microprocessor (cpu) is responsible for executing programs, processing data, and controlling system operation. Typically, high-performance, low-power processor architecture is used to support real-time calculation requirements for audio and video interfaces including intercom function, mobile phone use, or ar glass's function. The core function of ram in the memory module (ram and rom) is to temporarily store data and run programs, supporting fast data access and program execution.

The core function of rom is to store firmware and immutable programs, ensuring the stability and reliability of the system. The core function of power management unit (pmu) is to manage the charging and discharging process of flexible thin-film solar module, prioritize the charging and discharging of additional devices, and include the on-site supply of photovoltaic power to interconnected electronic communication equipment. The core function of the display interface is to drive and control the display module of mobile phone and micro display glasses, support high-resolution and high refresh rate display output, ensure image clarity and smoothness, and switch the display content of mobile phone to near eye display glasses when necessary. The core function of the sensor module is to connect and manage various sensors, such as imu (inertial measurement unit), optical tracker, ambient light sensor, etc.; provide real-time posture, position, and acceleration data for micro display glasses, supporting interaction with mobile applications and gps positioning, ai assisted functions. Audio and video interface for audio processing, with the core function of processing and outputting audio signals, supporting voice interaction and sound effect enhancement audio, micro display video, mobile phone audio (up to 5 audio playback locations, including left and right headphones installed on electronic communication hat, left and right speakers on micro display eyeglass frames, and mobile phone speakers placed at the back of the hat brim, which can achieve surround audio effect), may integrate audio codecs and microphone interfaces, supporting high-quality audio input and output. The core function of the wireless connection is to support wireless communication technologies such as wi-fi and bluetooth, enables data transmission and communication between batteries and other devices, and supports remote control and data sharing. The core function of camera interface is to drive and manage the camera module at the edge of the micro display glasses, supporting image capture and photography, video recording, high-resolution image processing and real-time video streaming, and optionally supporting gesture control menu selection. Other interfaces are for providing wired connection interfaces such as usb and hdmi, supporting fast data transfer and expansion functions with external devices. The ai processing unit integrates ai technology and supports intelligent functions such as image recognition and speech recognition, which can enhance the intelligence level of electronic communication hat and enable them to quickly respond to user needs.

for example, the driving device in the embodiments of the present invention further includes a mobile phone.

Based on the above embodiments, it already has the installation of headphones and rechargeable battery devices.

When using the mobile phone to implement gps navigation mode outdoors with a power consumption of 10 w, the connection of the mobile phone with a flexible thin-film solar module enables the mobile phone to obtain 8 watts of power even under a diffuse illumination of 250 w/m² in cloudy weather. The battery runtime is 4.42 ah·3.85/(10−8)=8.5 hours; compared with a mobile phone battery capacity of 4422 mah, and a lithium battery voltage of 3.85v, the battery runtime is 4.42 ah·3.85/10=1.7 hours if the user uses the phone outdoors to implement gps navigation mode with a power consumption of 10 w. This embodiment of the present invention greatly improves endurance of the mobile phone.

for another example, the driving device in the embodiment of the present invention includes display glasses. In the embodiment of the present invention, a pair of armless ar smart glasses are selected and installed on the front inner side of the hat brim for binocular display. Through a rotatable plastic shaft, one or two glasses can be flipped up, and the user is in the mode of not using the ar glasses; alternatively, one or two glasses can be flipped down in front of the eyes, and the user is in the mode of using ar glasses. Ar glasses are mainly based on micro oled technology and optical waveguide technology. Micro oled has a single eye resolution of 1080p with the brightness of 500-5000 nits and supports a refresh rate of 120 hz. The glasses not only support high-quality display of videos and games but also integrate micro cameras and photography lenses. Through the flyme xr 2.0 operating system, it supports multiple interaction methods, including touch display on the edge of the glasses, voice assistant and manual dial selection menu inside the brim, thus providing a rich user experience. FIG. 9 shows the schematic diagram of the connection between the electronic communication hat, mobile phone, and binocular display. It is connected through the output interface usb type c of the flexible thin-film solar module 10, and coordinated use is achieved through the logic control diagram shown in FIG. 10.

the advantage of this technology is that it can provide high-resolution and high contrast images in a small size, making it suitable for scenes such as ar/vr/xr glasses that require compact display devices. Optical waveguide technology may also consider for ar/vr/xr glasses display. It utilizes the principle of total reflection of light inside the lens to transmit images from the micro display to the user's eyes. The display system of smart glasses can even provide a 188-inch equivalent giant screen experience, supports a contrast ratio of 100000:1, covers 108% of srgb color gamut, and can present rich colors and details. The main advantage of optical waveguide technology is its ability to achieve lightweight and high transparency, making ar/vr/xr glasses look no different from ordinary glasses while providing clear image display. The difference between the embodiments of the present invention and ar/vr/xr glasses is that the display module, rechargeable battery and speaker are all integrated into the brim, body, and top of the hat. Considering the outdoor sunlight factor, a pair of foldable sunglasses are also installed outside the ar/vr/xr display glasses, so that users can choose whether to use the sunglasses' function.

the power consumption of display glasses varies in different scenarios. In simple text display and navigation, the main power consumption of near eye display is to maintain the operation of the display screen and basic sensors (such as gyroscopes and accelerometers), with a power consumption of 1 watt, which is relatively low; watching videos or movies, using voice technology, using ai function, high brightness display screen, image processing gpu and phone to speaker usage, typically consuming 1.5-2 watts, moderate power consumption; high resolution 3d display, virtual environment display, and complex navigation system are required, with a power consumption of 3-4 watts, which is relatively high. Near eye displays consume less energy than mobile phone displays, which is beneficial for energy conservation and increases the battery runtime of electronic communication hat.

when combine a mobile phone with 3d binocular display, the battery runtime is 4.42ah·3.85/(10+4)=1.21 hours. However, when used in an electronic communication hat and with a diffuse illumination of 250 w/m² on cloudy outdoor, the battery runtime is 4.42ah·3.85/(10+4−8)=2.8 hours to supply power to the phone. After the self-equipped battery of the mobile phone is depleted, the electronic communication hat is also equipped with a 10ah lithium-ion battery, which can increase the battery runtime by 10 ah·3.85/(10+4−8)=6.3 hours. Therefore, installing ar/vr/xr display glasses and sunglasses on the brim of the hat not only reduces the burden on the nose bridge caused by the heavy weight of existing ar/vr/xr glasses (usually 44-120 grams), but also greatly extends the battery runtime of ar/vr/xr glasses and mobile phones when used simultaneously. In outdoor environments, the battery runtime is extended from 1.21 hours to 9.1 hours, and under clear and sunny conditions, the battery runtime is even longer, greatly increasing the battery durance.

as an example, the driving device in the embodiments of the present invention includes display glasses that are monocular display. Based on the above embodiments, monocular display can free up one eye to observe the environment and achieve the fusion of virtual and reality. During monocular display, left and right glasses can be rotated to relieve fatigue from near eye reading or browsing web pages.

due to the semitransparent display of ar/vr/xr glasses, which are fixed inside the brim of the hat, users can wear them naturally and comfortably for a long time. The left and right ear microphones and speakers are distributed on the left and right sides of the hat brim, ensuring close ear listening to voice playback, user voice interaction, and directing the phone and display application. The shape of the electronic communication hat not only embodies traditional elegance and etiquette but also has a large surface area. It uses flexible thin-film solar module 10 to generate photovoltaic power under outdoor sunlight and indoor lighting, ensuring continuous charging and power supply, greatly improving battery runtime, and promoting green energy conservation, environmental protection, and carbon reduction. The electronic communication hat is equipped with a microcontroller or cpu, which contains a control chip that can be used to coordinate the display of mobile phone, visual ar/vr/xr glasses, speaker playback, voice reception and interaction, as well as to manage the power generation of flexible thin-film solar module.

the present electronic communication hat mainly includes the following parts: the outer surface of the hat composed of high-efficiency, flexible, and lightweight thin-film solar modules with advanced zone control to ensure reliability and stability; speakers and microphones are installed on both sides of the brim of the hat; the flexible thin-film solar module generates electricity on-site to support communication equipment both in outdoor and indoor lighting environments, and the rechargeable battery device stores excess photovoltaic electricity; there is a mobile phone insertion pocket, audio/video i/o port, and dc charging/discharging port located behind the brim of the hat; optionally installed liftable lightweight display glasses, cameras, speakers, etc. In front of the brim; the microprocessor is equipped with a built-in control chip, which is used to automatically control and coordinate the functions of various integrated devices, connect and control the speaker/microphone system; connect and control the display screen, video recording, photography system, etc.

optionally, the electronic communication hat also includes: a boost/buck converter, and a rechargeable battery device located on the inner side of the hat body; the buck boost converter is used to increase or decrease the voltage of flexible thin-film solar module to a suitable range for driving equipment.

among them, electronic converters are used to increase or decrease the voltage of flexible thin-film solar module, adapt to the voltage of various driving devices, and meet the voltage requirements of different driving devices; it is possible to increase and decrease the voltage of the electronic communication hat, and adjust the voltage and current as needed.

optionally, flexible thin-film solar module includes at least one cadmium telluride solar module, perovskite solar module, copper indium gallium selenide solar module, and organic thin-film solar module.

among them, flexible thin-film solar modules are made of single solar cells or tandem solar cells, and the tandem solar cells include double junction or triple junction solar cells. Layered photovoltaic technology can be achieved using perovskite solar cells and other flexible thin film photovoltaic technologies that can achieve dim light photoelectric conversion. Other flexible thin film photovoltaic technologies that can achieve dim light photoelectric conversion include organic semiconductor photovoltaics, cigs photovoltaics, inorganic semiconductor thin-film photovoltaics such as cadmium telluride (cdte), etc.

optionally, the substrate of the flexible thin-film solar cell is a flexible transparent polymer substrate, which constitutes the outer side of the electronic communication hat, and the inner side of the electronic communication hat is provided with an inner liner; the lining material includes reinforced natural fiber fabric or synthetic fiber fabric; the material of the flexible transparent polymer substrate includes any one of polyimide, polyethylene naphthalate, and polyethylene terephthalate.

among them, the light absorbing material of flexible thin-film solar modules is selected from single junction or multi junction solar cells composed of cadmium telluride (cdte), copper indium gallium selenide cigs, perovskite metal halides, and organic semiconductors, which have obvious photovoltaic properties in both strong and weak light, and meet the requirements of light, thin, and flexible, with a photovoltaic power conversion efficiency pce greater than 22%. The flexible thin film solar module can be a tandem perovskite solar cell, which includes a flexible transparent polymer substrate, a first hole transport layer, a first perovskite absorption layer, a first electron transport layer, a conductive layer, a second hole transport layer, a second perovskite absorption layer, a second electron transport layer, an electron transport hole blocking layer, and an electrode stacked in sequence; indium tin oxide (ito) conductive transparent polyimide film (thickness 25 um) can be used as a flexible transparent polymer substrate, and a photoelectric conversion efficiency of 27.8% can be achieved through conventional material settings. The open circuit voltage of a tandem perovskite solar cell is the sum of two cells, reaching v_{oc}=1.8 v. The short-circuit current varies greatly depending on the thickness, bandgap width, and the use and process of the connecting conductive layer material of the two cells. The filling factor is between 75-85%, and the overall power conversion efficiency of the tandem solar cells can be improved by 10-40%. For example, using perovskite and organic semiconductor stacked tandem solar cell technology, optimal technology can prepare solar cells with an energy conversion efficiency pce of 33%. Although the cost may increase for a tandem solar cell, additional power conversion efficiency improvement can be obtained.

in order to meet with the charging requirements of mobile phones, such as a standard charging voltage of 5v and a maximum current of 2 a (maximum total power of 10 w); the maximum charging voltage of quick charge can range from 5-12v, with a current of 2 a-1.67 a (maximum total power of 20 w). If the voltage is 12v and the current is 0.5-2 a, it is necessary to use multiple solar cells wherein they are connected to each other in parallel to increase the maximum open circuit voltage voc. In the formation of perovskite solar cells, using silver, copper, aluminum wires or their foil strips with good conductivity as current collection wires is beneficial for effectively transferring charges, reducing resistance, and improving voltage advantages. Under standard 1.5 g illumination, the open circuit voltage v_{oc} of a single perovskite cell is 1.0-1.3v; the short-circuit current j_{sc} is between 20-26 ma/cm2, which can be adjusted according to the material formula and the degree of manufacturing process improvement.

the flexible thin film solar cell used in the present invention is mainly made of perovskite abx3 material; the following example illustrates the detailed preparation steps of a nip single-cell perovskite solar cell. In practical preparation, reverse pin solar cells can also be used. The preparation of perovskite flexible thin film solar cells is a complex technological and process, and the selection, preparation, module preparation, and zoning management of materials all affect the performance, cost, and reliability of electronic communication hat.

here are some examples to illustrate the basic process of perovskite solar cells:

S1, preparation of perovskite precursor solution: perovskite materials are usually composed of organic metal halides, such as methylammonium lead iodide (ch₃nh₃pbi₃). It is not ruled out to use modified perovskite compounds in this formula, and other a, b, and other halogens x (such as i, br, cl) can be used to adjust the semiconductor bandgap e_{g} (ev), increase stability, prompt battery current, fill factor ff, and other measures. The preparation of precursor solutions requires the dissolution of organic cations (such as methylamine) and metal halides (such as lead iodide) in suitable solvents, typically high solubility, high polarity, low toxicity, and high boiling point (greater than 100 °c), such as dimethylformamide (dmf) or dimethyl sulfoxide (dmso). The selection of solvents can also include the addition of auxiliary chemicals such as passivating the surface of crystal materials and enhancing the 2d and 3d perfection of thin film crystals.

s2, flexible transparent conductive substrate: indium tin oxide (ito) or fluorine doped tin oxide (fto) conductive plastic is usually used as the substrate. For flexible substrates, plastics with good transparency such as pi polyimide, polyethylene naphthalene pen, and polyethylene terephthalate pet can be selected. These substrates have good conductivity, transparency, mechanical strength, and weather resistance, and are important components of perovskite cells.

s3, preparation of electron transport layer (etl): deposition of an etl on a substrate, commonly using inorganic materials such as titanium dioxide (tio₂) or modified tin oxide, or organic electronegative materials such as electrically deficient fullerene coo and its modified compounds, or other organic electronegative materials such as bcp (2,9-dimethyl-4,7-diphenyl-1,10-phenanthroline). Etl can be prepared by spin coating, spray pyrolysis or chemical vapor deposition (cvd); for organic etl materials, vacuum evaporation film-forming method can also be used. The function of etl is to promote the transport of electrons and prevent the transport of holes.

s4, preparation of perovskite absorbing layer: drop the perovskite precursor solution onto the substrate, and then use blade scraping, spin coating, or slit casting coating methods to evenly spread the solution and form a thin film, followed by further drying. The thickness and uniformity of the film are crucial for battery performance. For large-scale preparation, physical vapor deposition (pvd) and chemical vapor deposition (cvd) can also be used, which are suitable for the preparation of large-area devices. The vapor deposition method can avoid the use of solvents in spin coating, but it requires high equipment investment. The subsequent surface treatment process of thin films and the improvement of crystal thin films also have a significant impact on the efficiency and lifespan of solar cells.

s5, preparation of hole transport layer (htl): the function of htl is to extract and transport photo generated holes and deposit the hole transport layer (htl) on the perovskite layer. The commonly used material is spiro ometad [2,2′, 7,7′-tetra (n, n-p-methoxy aniline)-9,9′-spiro-bifluorene, n2, n2′, n2′, n7, n7′, n7′-octakis (4-methoxyphenyl)-9,9′-spiro-bifluorene-2,2′, 7,7′-tetraamine, cas: 207739-72-8], other htl organic materials or inorganic materials such as mno₃ can also be used. The use of conductive polymers can provide flexible, thin film htl functionality, such as pedot: pss conductive polymer, which is a polymer of edot (3,4-ethylenedioxythiophene monomer), and pss is polystyrene sulfonate. The combination of these two substances greatly enhances the solubility of pedot, facilitating solution film-forming process.

s6, preparation of metal electrodes: the function of metal electrodes is to collect charges and connect external circuits. Metal electrodes are deposited on htl through vacuum evaporation or sputtering techniques. Commonly used materials are gold (au), silver (ag), or copper (cu) carbon electrodes with good conductivity and high stability.

s7, encapsulation: encapsulation is an important step in protecting batteries, and flexible photovoltaic backplate encapsulation is usually carried out using commercially available photovoltaic backplates, such as pvb or poe, supplemented by butyl hot melt adhesive to prevent external factors such as water and oxygen from corroding the battery, thereby improving the stability and lifespan of the battery. The surface treatment of the device before packaging can also add functional layers such as moisture absorbing substances and environmentally friendly absorption of metal escape.

s8, testing and characterization: conduct photoelectric performance testing on the prepared battery, including measurement of parameters such as open circuit voltage v_{oc}, short-circuit current i_{sc}, fill factor ff, and photoelectric conversion efficiency pce. Using am 1.5 g to simulate the average sunlight intensity on earth (1000 w/m²) and compare the aging life under double 85 (temperature 85 °C and humidity 85%) conditions, long-term stability testing is conducted to evaluate the performance degradation of the battery under environmental conditions. In order to meet the above functions of the present invention, it is required that the working life of the battery (maintaining at least 85% of the initial pce) be greater than 4 years.

the preparation of perovskite solar cells involves multiple key steps, from material preparation to packaging and testing, each of which has a significant impact on the performance and stability of the cells. By optimizing these steps, the photoelectric conversion efficiency of the solar cells and their integration into module can be improved, production costs can be reduced, and the lifespan of the solar module can be extended. The optimized v_{oc} of the current single perovskite solar cell in the industry is 1.18 v, i_{sc}=26.99 ma/cm², the power conversion efficiency pce is 26.4%, and the long-term lifespan can reach 5 years, which basically meets the requirements of electronic communication hat and maintains the energy consumption requirements of mobile phone.

considering that the electronic communication hat body of the present invention is a hat that can be used for solar power generation, it can be used both indoors and outdoors; ensuring the use of photovoltaics to generate electricity supply is crucial under indoor lighting or in situations where outdoor sunlight is not too strong; under bright outdoor sunlight, the typical solar irradiance ranges from 500-1200 w/m², equivalent to 63k-130k lux, making power generation for electronic communication hat not a problem.

Under indoor lighting, such as in a laboratory and an operating room lighting at 1000-5000 lux is not a problem. In other indoor environments such as shopping malls (usually with an illuminance of 500-1000 lux), offices (usually with an illuminance of 300-500 lux), and residential areas (usually with an illuminance of 100-300 lux), it is also necessary to ensure the power generation function of electronic communication hat. Therefore, the electronic communication hat used must be selected from the following photovoltaic technologies: flexible thin-film solar modules with a photoelectric energy conversion efficiency pce of 20-50% in low light. Flexible thin film solar modules can meet the above pce power generation requirements, preferably perovskite thin film solar modules or stacked double junction solar modules combined with organic semiconductor thin film solar modules. Under artificial led lighting (5500k, 1000 lux), the power conversion efficiency pce of perovskite solar modules can exceed 20%, while traditional crystalline silicon solar cells typically have a pce of 10% or less, mainly due to the sensitivity of silicon-based cells to spectra and lower charge collection efficiency under low light conditions. Using perovskite materials, it has high absorption coefficients and charge mobility in visible and near infrared spectra and can achieve a photoelectric conversion efficiency of over 22% in low light conditions (such as indoor lighting), such as under a t184 light source of 1000 lux, using stacked cells such as double-tandem-junctions' solar cells.

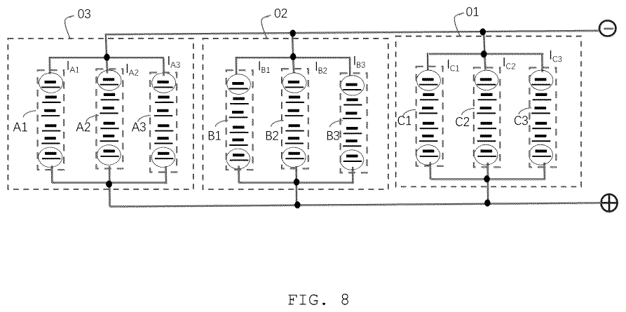

due to the specified dc voltage and current requirements for mobile phone, display glasses, and battery, the connection method shown in FIG. 8 has an overall voltage of 6 vx for the sub solar cell module when the sub solar cell is vx. In a single cell condition, the maximum voltage is 1.3v·6=7.8v, which can meet with general charging requirements; when using tandem solar cells as photovoltaic panels, the maximum output voltage is 2.7v·6=16v, which can meet the requirements of fast charging.

it should be understood that various forms of processes shown above can be used to reorder, add, or delete steps. For example, the steps described in the present invention can be executed in parallel, sequentially, or in different orders, as long as the desired results of the technical solution of the present invention can be achieved, and this article does not limit it here.

the above specific implementation methods do not constitute limitations on the scope of protection of the present invention. Technicians in this field should understand that various modifications, combinations, sub combinations, and substitutions can be made based on design requirements and other factors. Any modifications, equivalent substitutions, and improvements made within the spirit and principles of the present invention shall be included within the scope of protection of the present invention.

1. An electronic communication hat, characterized by comprising:
A flexible thin-film solar module, wherein the top, body, and brim of the electronic communication hat are all flexible thin-film solar modules; The flexible thin-film solar module on the top of the hat is the first solar cell module, the flexible thin-film solar module on the body of the hat is the second solar cell module, and the flexible thin-film solar module on the brim of the hat is the third solar cell module; The first solar cell module, the second solar cell module, and the third solar cell module are connected in parallel circuit; The flexible thin film solar module on the top of the hat comprises multiple first zones, each first zone being a sub solar cell module, and the multiple sub solar cell modules on the top of the hat are connected by a parallel circuit; The flexible thin film solar module of the hat body comprises multiple second zones, each second zone being a sub solar cell module, and the multiple sub solar cell modules of the hat body are connected by a parallel circuit; The flexible thin film solar module of the brim comprises multiple third zones with the same area, each third zone being a sub solar cell module, and the multiple sub solar cell modules of the brim are connected by a parallel circuit; Each sub solar cell module includes multiple sub solar cells, which are connected in series circuit; Anti-backflow device, used to prevent reverse current conduction of each sub solar cell module.

2. The electronic communication hat according to claim 1, characterized in that the anti-backflow device comprises: multiple anti-backflow diodes; The output terminal of each sub solar cell module is connected in series with an anti-backflow diode; The output terminal of the first solar cell module is connected in series with an anti-backflow diode, the output terminal of the second solar cell module is connected in series with an anti-backflow diode, and the output terminal of the third solar cell module is connected in series with an anti-backflow diode.

3. The electronic communication hat according to claim 1, further comprising:
A control device located on the inner side of the hat body, electrically connected to the flexible thin-film solar module; The anti-backflow device comprises multiple switches, and each sub solar cell module is connected in series with a switch; The control device is used to send a first control command to the flexible thin film solar module, and the flexible thin film solar module responds to the first control command to control the opening or closing of the corresponding sub solar cell module switch.

4. The electronic communication hat according to claim 2 or 3, further comprising:
A driving device located on the inner side of the brim or top of the hat;
The flexible thin-film solar module is used to supply power to the driving device; The control device is also used to send a second control instruction to the driving device, and the driving device responds to the second control instruction to perform the corresponding operation.

5. The electronic communication hat according to claim 4, further comprising:
A rechargeable battery device located on the inner side of the hat body; The battery device is used to store the electrical energy converted by the flexible thin-film solar module, or to supply power to the driving device.

6. The electronic communication hat according to claim 4, characterized in that the driving device comprises at least one display glass, a mobile phone, a speaker, a microphone, and a walkie-talkie.

7. The electronic communication hat according to claim 1, further comprising:
A buck boost converter located on the inner side of the hat body; The buck boost converter is used to increase or decrease the voltage of the flexible thin-film solar module.

8. The electronic communication hat according to claim 1, characterized in that the flexible thin film solar module comprises at least one of cadmium telluride solar module, perovskite solar module, copper indium gallium selenide solar module, and organic thin film solar module.

9. The electronic communication hat according to claim 8, characterized in that the flexible thin film solar module is made from a single solar cell or a tandem solar cell.

10. The electronic communication hat according to claim 1, characterized in that the substrate of the flexible thin film solar module is a flexible transparent polymer substrate, which is located on the outer side of the electronic communication hat, and the inner side of the electronic communication hat is provided with an inner liner;
The material of the inner lining includes reinforced natural fiber fabric or synthetic fiber fabric;
The material of the flexible transparent polymer substrate includes any one of polyimide, polyethylene naphthalate, and polyethylene terephthalate.
